(19) United States
(12) Patent Application Publication
(10) Pub. No.: US 2026/0101845 A1
(43) Pub. Date: Apr. 16, 2026

(54) ACTIVE FEEDER-HOUSE POSITION CONTROL FOR TERRAIN FOLLOWING HEADERS

(71) Applicant: Deere & Company, Moline, IL (US)

(72) Inventors: Hrishikesh S. TUPE, Pune (IN); Aditya D. CHAUDHARI, Pune (IN); Duane M. BOMLENY, Geneseo, IL (US); Alex A. BRIMEYER, Bettendorf, IA (US); Nathan R. VANDIKE, Geneseo, IL (US)

(21) Appl. No.: 18/912,053

(22) Filed: Oct. 10, 2024

(51) Int. Cl. A01D 41/14

(52) U.S. Cl. CPC A01D 41/141

(57) ABSTRACT

An agricultural harvester includes a header, a feeder-house, one or more processors, and memory storing instructions executable by the one or more processors. The instructions, when executed by the one or more processors, cause the one or more processors to: identify one or more topographic characteristics of upcoming terrain at a worksite based on data indicative of the one or more topographic characteristics of the upcoming terrain at the worksite; identify a future alignment between the header and the feeder-house at the upcoming terrain at the worksite based, at least, on the identified one or more topographic characteristics of the upcoming terrain at the worksite; identify one or more alignment adjustments based on the identified future alignment between the header and the feeder-house at the upcoming terrain at the worksite; and control one or more controllable subsystems of the agricultural harvester based on the identified one or more alignment adjustments.

### FIELD OF THE DESCRIPTION

The present description relates to agricultural work machines. More specifically, the present description relates to systems and methods for feeder-house position control for an agricultural harvester.

### BACKGROUND

There are a wide variety of different types of agricultural work machines. One example of an agricultural work machine is an agricultural harvester, such as a combine harvester, forage harvesters, windrowers, etc. An agricultural harvester includes a header that engages and cuts crop plants at an agricultural worksite, such as a field. As the agricultural harvester travels across the worksite, the header engages crop plants, cuts the crop plants, and transfers the cut crop material into the agricultural harvester for further processing. Headers can be arranged to follow the terrain (e.g., topography) of the worksite and to maintain a set height relative to the surface of the worksite to effectively engage and cut the crop plants.

The discussion above is merely provided for general background information and is not intended to be used as an aid in determining the scope of the claimed subject matter.

### SUMMARY

An agricultural harvester includes a header, a feeder-house, one or more processors, and memory storing instructions executable by the one or more processors. The instructions, when executed by the one or more processors, cause the one or more processors to: identify one or more topographic characteristics of upcoming terrain at a worksite based on data indicative of the one or more topographic characteristics of the upcoming terrain at the worksite; identify a future alignment between the header and the feeder-house at the upcoming terrain at the worksite based, at least, on the identified one or more topographic characteristics of the upcoming terrain at the worksite; identify one or more alignment adjustments based on the identified future alignment between the header and the feeder-house at the upcoming terrain at the worksite; and control one or more controllable subsystems of the agricultural harvester based on the identified one or more alignment adjustments.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a partial pictorial, partial schematic illustration showing an example agricultural harvester.

FIG. 2 is a partial pictorial, partial schematic illustration showing an example suspension system and attachment frame arrangement for an agricultural harvester.

FIG. 3 is pictorial illustration showing an example feeder-house and actuator arrangement for an agricultural harvester.

FIG. 4 is a diagrammatic illustration showing operation of an agricultural harvester at a worksite.

FIG. 5 is a block diagram of one example agricultural system architecture.

FIG. 6 is a block diagram showing some examples of components of the agricultural system architecture, including active alignment system, in more detail.

FIG. 7 shows a flow diagram illustrating one example operation of an agricultural system architecture in performing active alignment control.

FIG. 8 is a block diagram showing one example of items of an agricultural system architecture in communication with a remote server architecture.

FIGS. 9, 10, and 11 show examples of mobile devices that can be used in an agricultural system architecture.

FIG. 12 is a block diagram showing one example of a computing environment that can be used in an agricultural system architecture.

### DETAILED DESCRIPTION

For the purpose of promoting an understanding of the principles of the present disclosure, reference will now be made to the examples illustrated in the drawings, and specific language will be used to describe the same. It will nevertheless be understood that no limitation of the scope of the disclosure is intended. Any alterations and further modifications to the described devices, systems, methods, and any further application of the principles of the present disclosure are fully contemplated as would normally occur to one skilled in the art to which the disclosure relates. In particular, it is fully contemplated that one or more of the features, components, or steps described with respect to one example can be combined with one or more of the features, components, or steps described with respect to other examples of the present disclosure.

In one example, an agricultural harvester includes a header and a feeder-house. The header is movably attached to the feeder-house by an attachment frame assembly. The height set point of the header is set through ground-engaging members, such as gauge wheels. A suspension system applies a float force that allows the header to float, and thereby move, relative to the feeder-house. The float force is a lifting force oriented to maintain the header at the given distance (e.g., height set point) above the worksite. The arrangement allows the header to respond to changing terrain. If terrain underneath the header falls (e.g., the elevation of the worksite reduces), the header is weighted sufficiently to overcome the float force so that the header drops to follow the terrain downward. If the terrain underneath the header rises (e.g., the elevation of the worksite increases), then the ground-engaging members act to aid the float force in lifting the header to follow the terrain upward.

As the header follows the terrain, the alignment (or relative positioning) between the header and the feeder-house is changed. This can cause interruption of the conveyance of cut crop material from the header to the feeder-house and, ultimately, to other components of the agricultural harvester. Additionally, the extent to which the header can move relative to the feeder-house is somewhat limited by the position of the feeder-house, given the dimensionality, range of movement, and arrangement of the attachment frame assembly. Thus, in some instances, the feeder-house position may prevent the header from rising or lowering as desired, which can lead to crop loss (e.g., the header fails to engage or capture crop).

In some examples, sensors are used to detect the position of the header relative to the worksite. This sensor data can be used, in a closed-loop fashion, to react to changes in terrain of the worksite and to control the position of the feeder-house to maintain desired relative positioning between the header and the feeder-house. However, given that such control is reactive, some detrimental effects, such as interruption of conveyance of crop material or crop loss, may still occur.

Disclosed herein are systems and methods for identifying terrain changes ahead of the harvester, predicting an upcoming alignment (or relative positioning) between the header and the feeder-house, given the identified upcoming terrain changes, and proactively controlling the harvester to maintain desired alignment (or relative positioning) between the feeder-house and the header given the predicted upcoming alignment. By proactively controlling the alignment (or relative positioning), the detrimental effects, discussed above, can be reduced.

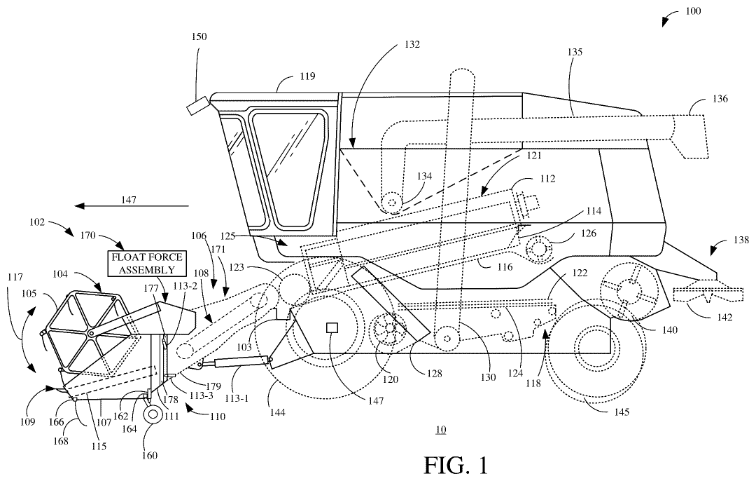

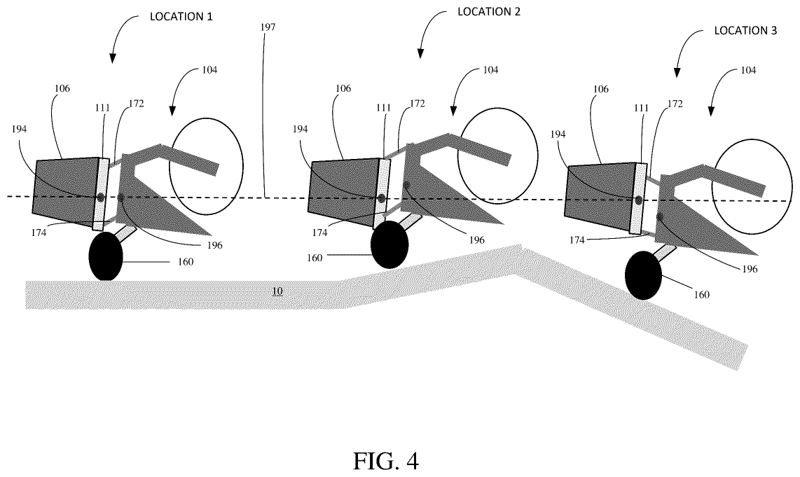

FIG. 1 is partial pictorial, partial schematic illustration of an example agricultural work machine 100 in the form of an agricultural harvester 100-1 (illustratively a combine harvester). Agricultural harvester 100-1 is also referred to as harvester 100-1. As illustrated in FIG. 1, harvester 100-1 includes ground engaging traction elements (wheels or tracks) 144 and 145 which can be driven by a propulsion subsystem (e.g., powerplant (e.g., internal combustion engine, etc.) hydrostatic drive, and other drivetrain elements, such as a gear box/transmission) to propel harvester 100-1 across a worksite 10 (e.g., a field). Harvester 100-1 includes an operator compartment or cab 119, which can include a variety of different operator interface mechanisms (e.g., 218 shown in FIG. 4) for controlling harvester 100-1 as well as for presenting (e.g., displaying, etc.) various information and providing for operator input. Harvester 100-1 includes a feeder-house 106, a feed conveyor assembly 108, and a feed accelerator 123. The feeder-house 106, the feed conveyor assembly 108, and the feed accelerator 123 form part of a material handling subsystem 125.

Harvester 100-1 includes a set of front-end equipment forming a cutting platform 102 that includes a header 104 that includes a cutter (or cutter bar) generally indicated at 109. Harvesters, such as harvester 100-1, can be equipped with various types of cutting platforms that are designed for particular crops. One example, sometimes called a grain platform, is equipped with a reciprocating knife cutter (or cutter bar), and features a revolving reel with metal or plastic fingers to cause the cut crop to fall into a cross-auger once it is cut. Another example includes a cutter (or cutter bar) that can flex over contours and ridges to cut crops such as soybeans that have pods close to the ground. Some headers designed for wheat, or other similar crops, include draper headers, and use a fabric or rubber apron instead of a cross-auger. Often, a draper platform includes one or more draper belts that move cut crop material, that is harvested from an agricultural field, into the harvester. In one example, this includes one or more draper belts on each side of the header configured to receive and move cut crop material to a center section of the agricultural header. In the example shown in FIG. 1, the cutting platform 102 is a grain platform.

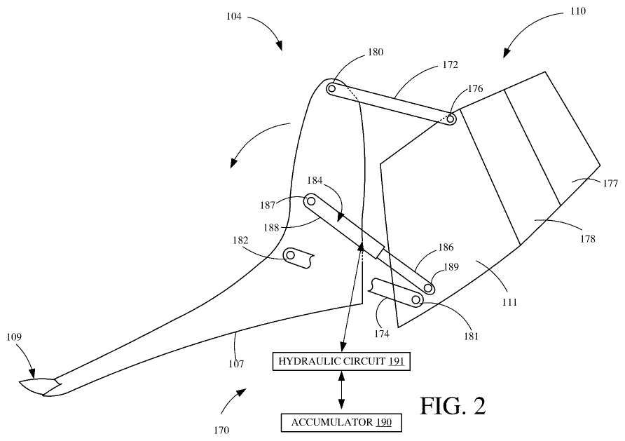

As shown in FIG. 1, header 104 has a main frame 107. Header 104 is movably (e.g., pivotably) attached to feeder-house 106 by an attachment frame assembly 110 (shown in more detail in FIG. 2). Attachment frame assembly 110 includes an attachment frame 111, as well as other items, as will be shown below in FIG. 2. Feeder-house 106 includes a frame assembly 171 including a plurality of sub-frames (illustratively sub-frame 177, sub-frame 178, and sub-frame 179). In the example shown in FIG. 1, sub-frame 179 comprises a main frame of feeder-house 106. Sub-frame 177 is moveably coupled to sub-frame 179 and sub-frame 178 is moveably coupled to sub-frame 177. Attachment frame 111 is fixed (or fixably coupled) to sub-frame 178 and is moveably coupled to header 104. Header 104 can be uncoupled from harvester 100-1 by uncoupling attachment frame 111 from the feeder-house frame assembly. Main frame 107 supports cutter 109 and reel 105 and is moveable relative to attachment frame 111. Header 104 further includes one or more ground engaging members 160 (illustratively gauge wheels) coupled to header 104 and configured to engage a surface of the worksite. In some examples, a ground engaging member 160 (such as a gauge wheel) can be at each side of the header 104. Header 104 further includes one or more ground engaging member actuators 162 that are each actuatable to change a position of a respective ground engaging member 160 relative to the header 104 to set a height set point or to change a position of header 104. In other examples, header 104 can include a suspension system for ground engaging members 160, such as spring (e.g., coil spring). In some examples, the stiffness (e.g., spring force) of the suspension system for the ground engaging members 160 can be adjustable.

Harvester 100-1 also includes a float force assembly 170, which acts as a suspension for header 104. Float force assembly 170 is shown schematically in FIG. 1 and applies a float force, that is illustratively a lifting force that acts against gravity, biasing main frame 107 of header 104 in an upward direction. Therefore, as the terrain under header 104 rises, the ground engaging members 160 on header 104 engage the rising terrain and push upwardly on header 104 and, in combination with the float force, cause header 104 to rise. As the terrain under header 104 falls, the weight of header 104 overcomes the float force so that header 104 descends and ground engaging members 106 engage the falling terrain.

Feeder-house 106 (e.g., sub-frame 171) is pivotally coupled to a frame 103 of harvester 100-1. Harvester 100-1 includes a plurality of actuators 113 (illustratively 113-1, 113-2, and 113-3) for adjusting the position (e.g., height, tilt, roll) of feeder-house 106 (or feeder-house frame assembly 171) and, by virtue of coupling, the position of attachment frame 111 and thus, header 104. One or more actuators 113-1 drive movement of feeder-house 106 about an axis in the directions generally indicated by arrow 117. Thus, a position (e.g., height) of feeder-house 106 above the surface of the worksite, and relative to the header 104, is controllable by actuating the one or more actuators 113-1. Movement of actuators 113-1 can also cause movement of header 104 by virtue of the connection between feeder-house 106 and header 104 by way of attachment frame assembly 110. One or more actuators 113-2 are actuatable to change a roll of feeder-house (or feeder-house frame assembly 171) and, by virtue of coupling, change the roll of attachment frame 111 and thus, change a roll of header 104. As shown, actuators 113-2 are coupled between sub-frame 178 and sub-frame 177. Actuators 113-2 are operable to cause roll movement of sub-frame 178, and thus, sub-frame 178 can be referred to as a roll frame (or a side-to-side tilt frame). Roll movement of sub-frame 178 also, by virtue of coupling, causes roll movement of attachment frame 111 and thus, roll movement of header 104. Though only one actuator 113-2 is shown, it will be understood that there may be multiple actuators 113-2, such multiple actuators 113-2 spaced apart across sub-frame 178. One or more actuators 113-3 are actuatable to change a tilt or pitch of feeder-house 106 (or feeder-house frame assembly 171) and, by virtue of coupling, change the tilt or pitch of attachment frame 111 and thus, change the tilt or pitch of header 104. As shown, actuators 113-3 are coupled between sub-frame 179 and sub-frame 177. Actuators 113-3 are operable to cause pitch (or fore-to-aft tilt) movement of the sub-frame 177, and thus, sub-frame 177 can be referred to as a pitch (or tilt) frame (or a fore-to-aft pitch (or tilt) frame). Pitch movement of sub-frame 177 also, by virtue of coupling, causes pitch movement of sub-frame 177, and thus, pitch movement of attachment frame 111, and thus, pitch movement of header 104. Though only one actuator 113-3 is shown, it will be understood that there may be multiple actuators 113-3, such as multiple actuators 113-3 spaced apart along sub-frame 177.

Material handling subsystem 125 further includes a thresher 121 which illustratively includes a threshing rotor 112 and a set of concaves 114. Further, material handling subsystem 125 also includes a separator 116. Agricultural harvester 100-1 also includes a cleaning subsystem or cleaning shoe (collectively referred to as cleaning subsystem 118) that includes cleaning fan(s) 120, chaffer 122, and sieve 124. The material handling subsystem 125 also includes discharge beater 126, tailings elevator 128, and clean grain elevator 130. The clean grain elevator moves clean grain into a material receptacle (or clean grain tank) 132.

Harvester 100-1 also includes an unloading subsystem that includes a conveying mechanism 134 and a chute 135. Chute 135 includes a spout (or flap) 136. In some examples, spout 136 can be movably coupled to chute 135 such that spout 136 can be controllably rotated to change the orientation of spout 136 relative to chute 135. Conveying mechanism 134 can be a variety of different types of conveying mechanisms, such as an auger or blower. Conveying mechanism 134 is in communication with clean grain tank 132 and is driven (via a conveying mechanism drive assembly) to convey material (e.g., grain) from grain tank 132 through chute 135 and spout 136. Chute 135 is rotatable through a range of positions from a storage position (shown in FIG. 1) to a variety of deployed positions away from agricultural harvester 100-1 to align spout 136 relative to a material receptacle of a material receiving machine that is configured to receive the material within grain tank 132. Spout 136, in some examples, is also rotatable, by an actuator, to adjust the direction of the material stream exiting spout 136.

Harvester 100-1 also includes a residue subsystem 138 that can include chopper 140 and spreader 142. In some examples, a harvester within the scope of the present disclosure can have more than one of any of the subsystems mentioned above. In some examples, harvester 100-1 can have left and right cleaning subsystems, separators, etc., which are not shown in FIG. 1.

In operation, and by way of overview, harvester 100-1 illustratively moves through worksite 10 in the direction indicated by arrow 147. As harvester 100-1 moves, header 104 engages the crop plants to be harvested and cuts, with cutter bar 109 on the header 104, the crop plants to generate cut crop material. The cut crop material can be engaged by reel 105 of header 104. Reel 105 moves the cut crop material to a conveyor 115.

The cut crop material is engaged by conveyor 115 (illustratively one or more draper belts) which conveys the severed crop material to a center of the header 104 where the severed crop material is then moved through an opening to a feed conveyor assembly 108 in feeder-house 106 toward feed accelerator 123, which accelerates the cut crop material into thresher 121. The cut crop material is threshed by rotor 112 rotating the crop against concaves 114. The threshed crop material is moved by a separator rotor in separator 116 where a portion of the threshed crop material (e.g., material other than grain (MOG)) is moved by discharge beater 126 toward the residue subsystem 138. The portion of residue transferred to the residue subsystem 138 is chopped by residue chopper 140 and spread on the field by spreader 142. In other configurations, the residue is released from the agricultural harvester 100-1 in a windrow.

Some of the threshed crop material, including grain and some pieces of MOG falls to cleaning subsystem 118. Chaffer 122 separates some larger pieces of MOG from the grain, and sieve 124 separates some of finer pieces of MOG from the grain. The grain then falls to an auger that moves the grain to an inlet end of grain elevator 130, and the grain elevator 130 moves the grain upwards, depositing the grain in grain tank 132. MOG is removed from the cleaning subsystem 118 by airflow generated by one or more cleaning fans 120. Cleaning fans 120 direct air along an airflow path upwardly through the sieves and chaffers. The airflow carries MOG rearwardly in harvester 100-1 toward the residue handling subsystem 138.

Tailings elevator 128 returns tailings to thresher 121 where the tailings are re-threshed. Alternatively, the tailings also can be passed to a separate re-threshing mechanism by a tailings elevator or another transport device where the tailings are re-threshed as well.

Harvester 100-1 can include a variety of sensors, some of which are illustrated in FIG. 1, such as one or more ground speed sensors 146, one or more observation sensor system 150, and header position sensors 164 and 166.

Ground speed sensor 146 senses the travel speed of harvester 100-1 over the ground. Ground speed sensor 146 can sense the travel speed of the harvester 100-1 by sensing the speed of rotation of the ground engaging traction elements 144 or 145, or both, a drive shaft, an axle, or other components. In some instances, the travel speed can be sensed using a positioning system, such as a global positioning system (GPS), a dead reckoning system, a long-range navigation (LORAN) system, a Doppler speed sensor, or a wide variety of other systems or sensors that provide an indication of travel speed. Ground speed sensors 146 can also include direction sensors such as a compass, a magnetometer, a gravimetric sensor, a gyroscope, GPS derivation, to determine the direction of travel in two or three dimensions in combination with the speed. This way, when harvester 100-1 is on a slope, the orientation of harvester 100-1 relative to the slope is known. For example, an orientation of harvester 100-1 could include ascending, descending or transversely travelling the slope.

Observation sensor systems 150 can include one or more of a variety of sensors, such as cameras or time-of-flight sensors, such as lidar sensors, radar sensors, ultrasonic sensors, as well as a variety of other sensors. Observation sensor systems 150 illustratively detect the terrain (and topographic characteristics (e.g., elevation, slope, etc.) thereof) of the worksite 10 around harvester 100-1. For example, observation sensor systems 150 can detect the terrain (and topographic characteristics thereof) ahead of header 104 relative to the travel direction 147 of harvester 100-1. Observation sensors 150 can, additionally, detect various other characteristics, such as, but not limited to, material flow characteristics as discussed elsewhere herein. While FIG. 1 shows some example positions of an observation sensor system 150, it will be understood that observation sensor systems 150 can, alternatively or additionally, be positioned (or otherwise disposed) at a variety of other locations on harvester 100-1.

Header position sensors 164 and 166 illustratively detect a position (e.g., a height, a tilt, a roll) of header 104 relative to the surface of the worksite 110. For example, header position sensors 164 can each detect an angular position of a respective ground engaging member 106 relative to header 104 to detect a position of header 104. Header position sensors 166 can be placed at one or more locations along the width of header 104, such as along the width of the cutter bar 109, and can detect the angular position of a ground engaging rod 168 (that engages the surface of the worksite 10) relative to header 104 to detect a position of header 104. Header position sensors 164 and 166 can be various types of sensors such as transducers or potentiometers. Other types of sensors can be employed to detect a position of header 104, such as time-of-flight sensors.

A harvester 100 can include various other sensors, some of which will be described in FIG. 4. A harvester 100 can include various other items, some of which will be described in FIG. 4.

FIG. 2 shows one example of some portions of harvester 100-1, including attachment frame assembly 110 and float force assembly 170 in more detail. FIG. 2 shows that main frame 107, which supports cutter 109 and reel 105 (not shown in FIG. 2) is at a first position relative to attachment frame 111. Attachment frame 111 is fixably coupled to feeder-house frame assembly 171 (e.g., sub-frame 178) and moveably attached to main frame 107 Sub-frame 178 is moveably coupled to sub-frame 177 and sub-frame 177 is moveably coupled to sub-frame 179 (not shown in FIG. 2). The vertical movement of main frame 107 relative to attachment frame 111 is illustratively driven by ground engaging members 160 (such as gauge wheels as shown in FIG. 1, or other types of ground engaging members such as shoes or skis) which act to raise and lower main frame 107 relative to attachment frame 111 as the ground over which the ground engaging members move rises and falls, respectively. The position (e.g., height, tilt, roll) of frame 107 and thus the position (e.g., height, tilt, roll) of the header 104 can also be changed by virtue of actuation of actuators 113 and attachment frame assembly 110.

In the example illustrated in FIG. 2, float force assembly 170 includes a suspension linkage including a set of control arms 172 and 174. Control arms 172 and 174 are pivotally connected to attachment frame 111 at pivot points 176 and 181 and are pivotally attached to main frame 107 at pivot points 180 and 182, respectively. Control arms 172 and 174 control the path of movement of main frame 107 relative to attachment frame 111 when the position of main frame 107 relative to attachment frame 111 hanges. It will be understood that another control arm, parallel to control arm 172, can be disposed on the other side of the header 104. It will be understood that another control arm, parallel to control arm 174, can be disposed on the other side of header 104. Thus, it will be understood that the suspension linkage can be a four-bar suspension linkage. This is just one example of an arrangement for controlling the path of movement.

Float force assembly 170 illustratively includes a hydraulic cylinder 184 that is pivotally connected to attachment frame 111 at pivot point 187, and that is pivotally attached to main frame 107 at pivot point 189. Hydraulic cylinder 184 has a rod portion 186 reciprocally mounted within cylinder portion 188. Assembly 170 also illustratively includes an accumulator 190. Accumulator 190 is shown schematically in FIG. 2 and is shown coupled to cylinder 184, through a hydraulic circuit 191. It will be appreciated that, in one example, accumulator 190 can be internal to hydraulic cylinder 184. In another example, accumulator 190 and circuit 191 can be separate from hydraulic cylinder 184 and fluidically coupled to hydraulic cylinder 184. In one example, float force assembly 170 can include another hydraulic cylinder (similar to hydraulic cylinder 184) disposed in spaced relation to hydraulic cylinder 184. The other hydraulic cylinder can also include or be coupled to an accumulator (similar to accumulator 190) via a hydraulic circuit (similar to hydraulic circuit 191). This is just an example.

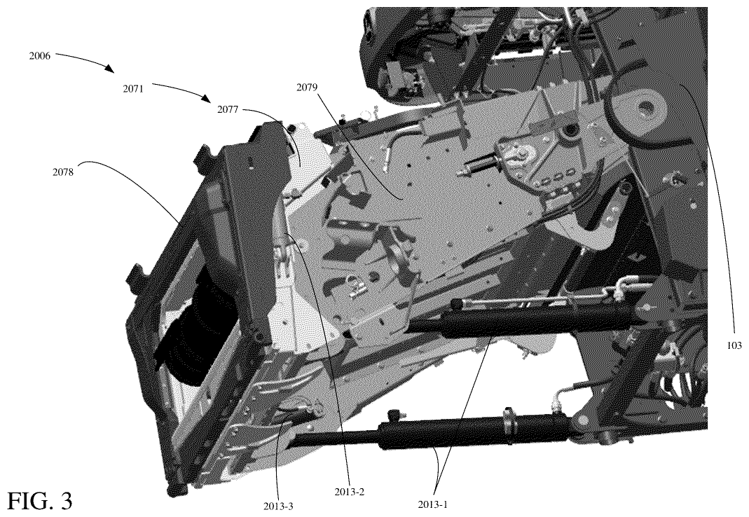

FIG. 3 shows one example of some portions of harvester 100-1, including one example of feeder-house 106. Feeder-house 2006 is one example of feeder-house 106. Feeder-house 2006 includes a frame assembly 2071 which is one example of frame assembly 171. Frame assembly 2071 includes sub-frame 2077, sub-frame 2078, and sub-frame 2079. Sub-frame 2077 is one example of sub-frame 177, sub-frame 2078 is one example of sub-frame 178, and sub-frame 2079 is one example of sub-frame 179. FIG. 3 also shows, as one example of actuators 113, actuators 2013. As shown in FIG. 3, it can be seen that harvester 100-1 can include one or more actuators 2013-1, which are one example of actuators 113-1, one or more actuators 2013-2, which are one example of actuators 113-2, and one or more actuators 2013-3, which are one example of actuators 113-3.

FIG. 4 illustrates one example operation of a harvester 100-1 as it travels across a worksite. At location 1, it can be seen that feeder-house 106 and header 104 have an alignment (relative positioning) such that a reference point 194 corresponding to feeder-house 106 and a reference point 196 corresponding to header 104 are in desired (or target) alignment (illustratively colinear (as represented by reference line 197) in the example of FIG. 4). It will be understood that a reference point, such as reference point 194 or reference point 196, is a particular portion of the item to which the reference point corresponds and has known coordinates on the corresponding item (i.e., the reference point has a known distances from other portions of the component). The systems and methods described herein, in at least some examples, provide for finding a position (e.g., location, height above surface of worksite, etc.) of reference points (e.g., 194 and 196) and for controlling a machine 100 (e.g., harvester 100-1) such that the reference points are in desired positions to provide for desired alignment (or relative positioning) between components (e.g., header 104 and feeder-house 106) of machine 100 (e.g., harvester 100-1).

In the example of FIG. 4, a colinear alignment (or relative positioning) between feeder-house 106 and header 104 is the desired alignment (or relative positioning). However, in other examples, the desired alignment (or relative positioning) may be different (and can be operator or user selectable or selected by a control system). For example, the desired alignment (or relative positioning) can be a range of acceptable alignments (or relative positionings). One example of a desired alignment (or relative positioning) is referred to herein as a fifty percent (50%) alignment (or relative positioning) which commands that the feeder-house 106 (or a reference point, such as 194, of the feeder-house 106) be positioned at the approximate center of the range of movement of the suspension linkage. In other examples, a desired alignment (or relative positioning) may be in a range across the range of movement of the suspension linkage, for instance, a desired alignment (or relative positioning) between 30-70% which commands that the feeder-house 106 (or a reference point, such as 194, of the feeder-house 106) be positioned at a position between 30-70% of the range of movement of the suspension linkage. For instance, it may be desirable to keep the feeder-house 106 (or a reference point thereof) positioned closer to the center of the range of movement of the suspension linkage as opposed to the ends of the range of movement of the suspension linkage. These are merely some examples.

As the harvester 100-1 travels to location 2, where the terrain of worksite 10 rises, the alignment (relative positioning) between feeder-house 106 and header 104 changes such that the reference points 194 and 196 are no longer colinear (as can be seen, header 104, and reference point 196, have shifted upwards with the rising terrain at location 2). The relative positioning between the feeder-house 106 and the header 104 at location 2 can cause material feeding issues and may prevent header 104 from raising sufficiently to maintain the desired height of header 104 above the worksite 10 such that header 104 may cut crop plants too low (e.g., too low relative to a desired cutting height).

As the harvester 100-1 travels to location 3, where the terrain of the worksite 10 falls, the alignment (relative positioning) between feeder-house 106 and header 104 changes such that the reference points 194 and 196 are no longer colinear (as can be seen, header 104, and reference point 196, have shifted downwards with the falling terrain at location 3). The relative positioning between the feeder-house 106 and the header 104 at location 2 can cause material feeding issues and may prevent header 104 from raising sufficiently to maintain the desired height of header 104 above the worksite 10 such that header 104 may cut crop plants too low (e.g., too low relative to a desired cutting height).

In the example of FIG. 3, a harvester 100-1 having an active alignment control system 215, as described herein, would identify the terrain at locations 2 and 3, prior to the harvester 100-1 reaching the terrain at locations 2 and 3, would predict the position of header 104 at locations 2 and 3 (e.g., predict the position of a reference point, such as 196, at locations 2 and 3), prior to the header 104 reaching the terrain at locations 2 and 3, and would proactively control the harvester 100 (e.g., actuator 107, actuators 162, etc.) to establish a desired alignment (relative positioning) between feeder-house 106 and header 104 at locations 2 and 3.

It will be understood that while the reference point 194 corresponding to the feeder-house 106 is shown as being located on attachment frame 111 this need not be the case. Because attachment frame 111 is fixably attached to and moves with the feeder-house 106 (at least in the illustrated example) the reference point 194 being located on the attachment frame 111 as illustrated operates to represent a position of the feeder-house 106. It will be understood that the reference point 196 can be located elsewhere, such as on a component of feeder-house 106, such as frame assembly 171.

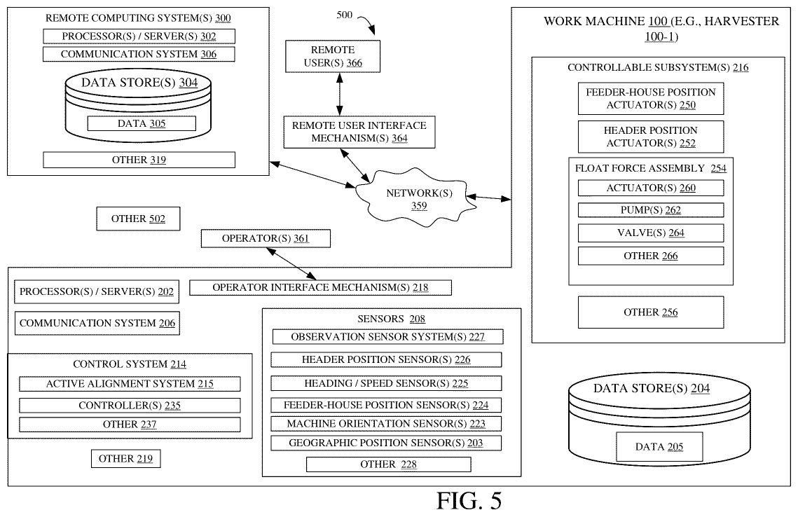

FIG. 5 is a block diagram showing one example agricultural system architecture 500 (hereinafter also referred to as agricultural system 500 or as system 500). Agricultural system 500 includes an agricultural work machine 100 (e.g., harvester 100-1, etc.), one or more remote computing systems 300, one or more networks 359, one or more remote user interface mechanisms 364, and can include a variety of other items 502 as well.

Work machine 100, itself, illustratively includes one or more processors or servers 202, one or more data stores 204, communication system 206, one or more sensors 208, control system 214, one or more controllable subsystems 216, one or more operator interface mechanisms 218, and can include various other items and functionality 219 as well.

Remote computing systems 300, as illustrated, each include one or more processors or servers 302, one or more data stores 304, communication system 306, and can include various other items and functionality 319.

Data stores 204 and data stores 304 each store a variety of data (generally indicated as data 205 and data 305, respectively), some of which will be described in more detail herein. For example, data 205 and data 305, or a combination thereof, can include, among other things, worksite data, historical data, sensor data, machine data, control data, machine alignment data, as well as various other data. Some examples of the various data will be described in more detail in FIG. 5. Additionally, data 205 can include computer executable instructions that are executable by one or more processors or servers 202 to implement other items or functionalities of system 500, including other items or functionalities of agricultural work machines 100. Additionally, data 305 can include computer executable instructions that are executable by one or more processors or servers 302 to implement other items or functionalities of system 500, including other items of remote computing systems 300. It will be understood that data stores 204 and data stores 304 can include different forms of data stores, for instance both volatile data stores (e.g., Random Access Memory (RAM)) and non-volatile data stores (e.g., Read Only Memory (ROM), hard drives, solid state drives, etc.).

Sensors 208 can include one or observation sensor systems 227, one or more header position sensors 226, one or more heading/speed sensors 225, one or more feeder-house position sensors 224, one or more orientation sensors 223, one or more geographic position sensors 203, and can include various other sensors 228 as well.

Heading/speed sensors 225 detect a heading characteristic (e.g., travel direction) or speed characteristic (e.g., travel speed, acceleration, deceleration, etc.), or both, of a work machine 100. This can include sensors that sense the movement (e.g., rotation) of ground-engaging elements (e.g., wheels or tracks) or movement of components coupled to the ground engaging elements (e.g., axles) or other elements, or can utilize signals received from other sources, such as geographic position sensors 203. Thus, while heading/speed sensors 225 as described herein are shown as separate from geographic position sensors 203, in some examples, machine heading/speed is derived from signals received from geographic position sensors 203 and subsequent processing. In other examples, heading/speed sensors 225 are separate sensors and do not utilize signals received from other sources. One example of heading/speed sensors 225 are sensors 146 shown in FIG. 1.

Geographic position sensors 203 illustratively sense or detect the geographic position or location of a work machine 100. Geographic position sensors 203 can include, but are not limited to, a global navigation satellite system (GNSS) receiver that receives signals from a GNSS satellite transmitter. Geographic position sensors 203 can also include a real-time kinematic (RTK) component that is configured to enhance the precision of position data derived from the GNSS signal. Geographic position sensors 203 can include a dead reckoning system, a cellular triangulation system, or any of a variety of other geographic position sensors.

Machine orientation sensors 223 detect an orientation (e.g., pitch, roll, and yaw) of work machine 100. Machine orientation sensors 223 can include an inertial measurement unit (IMU) (which can include one or more accelerometers, one or more gyroscopes, and one or more magnetometers).

Observation sensor systems 227 detect terrain (and topographic characteristics thereof) of a worksite at which the work machine 100 is located, including terrain ahead of the work machine 100 (e.g., ahead of a header (e.g., 104)) relative to a travel direction or route of the work machine 100. Topographic characteristics can include elevation, slope, as well as other topographic characteristics. One example of observation sensor systems 227 are observation sensor systems 150 shown in FIG. 1. Additionally, observation sensors 227 can detect material flow characteristics of material (e.g., crop material, etc.) directed by header 104 toward feeder-house 106 of work machine 100 (e.g., harvester 100-1). Material flow characteristics include flow consistency, flow speed, as well as other characteristics. Material flow characteristics can be detected by detecting bunching, pulsing, bumps, motion or lack thereof (e.g., stalling, stopping, etc.), of the material directed by header 104 toward feeder-house 106. Observation sensors 227 can detect the material as it is on and being conveyed by header 104 or can detect the material in other locations.

Header position sensors 226 detect a position (e.g., one or more of height, tilt, or roll) of a header (e.g., 104) of work machine 100. In some examples, header position sensors 226, such as transducers or potentiometers, detect an angular position of a ground engaging element (e.g., ground engaging member 160, ground engaging rod 168, etc.) to detect a position of the header. In some examples, header position sensors 226, such as time-of-flight sensors, detect a distance between the header and the surface of the worksite to detect a position of the header. Some examples of header position sensors 226 are header position sensors 166 and 168 shown in FIG. 1.

Feeder-house position sensors 224 detect a position (e.g., one or more of height, tilt, or roll) of a feeder-house (e.g., 106) of work machine 100. In some examples, feeder-house position sensors 224, such as transducers or potentiometers, detect an angular position of the feeder-house relative to a frame (e.g., 103) of the work machine 100 to detect a position of the feeder-house. In some examples, feeder-house position sensors 224, such as time-of-flight sensors, detect a distance between the feeder-house and the surface of the worksite to detect a position of the feeder-house. In some examples, feeder-house position sensors 224, such as pressure sensors or linear displacement sensors, detect a characteristic relative to a feeder-house actuator, such as a fluid pressure or displacement of the actuator, to detect a position of the feeder-house. In another example, feeder-house position sensors 224 can include an inertial measurement unit (IMU), or sensors such as accelerometers or gyroscopes, or both, that detect a height, tilt, or roll of the feeder-house.

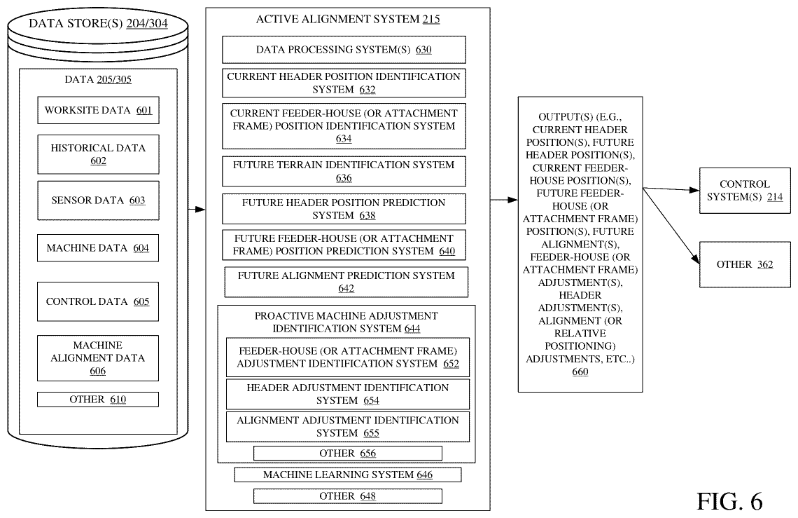

Control system 214 can include active alignment system 215. Briefly, active alignment system 215 monitors and controls alignment (or relative positioning) between a header (e.g., 104) and a feeder-house (e.g., 106) of work machine 100. Active alignment system 215 will be discussed in more detail in FIG. 6.

Control system 214 can include one or more controllers 235 (e.g., electronic control units, which can be implemented by one or more processors, such as one or more processors 202) that generate control signals to control one or more components of a work machine 100 or components of system 500, or both. For example, but not by limitation, controllers 235 can include, a communication system controller to control communication system 206, an interface controller to control one or more interface mechanisms (e.g., 218 or 364, or both), a header position controller that controls one or more header position actuators 252, a feeder-house position controller that controls one or more feeder-house position actuators 250, a float force controller that controls float force assembly 254, as well as various other controllers to control various other controllable subsystems 216. In other examples, a central controller can be used to generate control signals to control a plurality of the controllable subsystems 216 as well, in some examples, other items of system 500. Thus, it will be understood that a distinct controller can be used to control a distinct item or distinct subsystem of a work machine 100 or that a controller can control a plurality of items or a plurality of subsystems of a work machine 100, including a controller that controls all items (including all subsystems) of a work machine 100. Control system 214 can include various other items 237 as well.

Controllable subsystems 216 include one or more feeder-house position actuators 250, one or more header position actuators 252, float force assembly 254, as well as various other subsystems 216.

Feeder-house position actuators 250 are controllably actuatable to adjust and set a position of a feeder-house (e.g., 106) of work machine 100, or of a component of feeder-house 106 such as frame assembly 171 or a sub-frame thereof. Feeder-house position actuators 250 can include, for example, fluid actuators such as hydraulic actuators or pneumatic actuators. Feeder-house position actuators 250 can include, for example, electro-mechanical actuators (e.g., linear actuators). Some examples of feeder-house position actuators 250 are actuators 113 (e.g. 113-1, 113-1, 113-2) shown in FIG. 1 or actuators 2013 (e.g., 2013-1, 2013-2, 2013-3) shown in FIG. 3.

Header position actuators 252 are controllably actuatable to adjust and set a position of a header (e.g., 104) of work machine 100. Header position actuators 252 can include, for example, fluid actuators such as hydraulic actuators or pneumatic actuators. Header position actuators 252 can include, for example, electro-mechanical actuators (e.g., linear actuators). Some examples of header position actuators 252 are actuators 162 shown in FIG. 1.

It will be understood that some actuators (e.g., 113, 2013) operate to change a position (e.g., height, tilt, roll) of an attachment frame (e.g., 111) and thereby also operate to change a position of a header (e.g., 104), by virtue of the connection between the header and the attachment frame.

Float force assembly 254 is controllable to adjust and set a float force applied to header 104. One example of float force assembly 254 is float force assembly 170 shown in FIGS. 1-2. Float force assembly 254 can include one or more actuators 260, such as actuators 184, one or more pumps 262, one or more valves 264, and one or more other items, such as a hydraulic circuit (e.g., 191) and one or more accumulators (e.g., 190). Pumps 262 and valves 264 are controllable to control the flow and volume of hydraulic fluid within and between items of float force assembly 254, such as to adjust or set the float force applied to the header 104.

Communication system 206 is used to communicate between components of work machine 100 or with other items of system 500, such as remote computing systems 300, or user interface mechanisms 364, or a combination thereof. Communication system 306 is used to communicate between components of a remote computing system 300 or with other items of system 500, such as work machine 100, other remote computing systems 300, or user interface mechanisms 364, or a combination thereof.

Communication systems 206 and 306 can each include one or more of wired communication circuitry or wireless communication circuitry, as well as wired and wireless communication components. In some examples, communication systems 206 and 306 can each be one or more of a system for communicating over the Internet, a system for communicating over a cellular network, a system for communicating over a wide area network or a local area network, a system for communicating over a controller area network (CAN), such as a CAN bus, a system for communicating over a controller area network flexible data-rate (CAN FD), such as CAN FD bus, a system for communicating over a near field communication network, a system for communicating over ethernet, or a communication system configured to communicate over any of a variety of other networks. Communication systems 206 and 306 can each also include a system that facilitates downloads or transfers of information to and from a secure digital (SD) card or a universal serial bus (USB) card, or both. Communication systems 206 and 306 can each utilize network 359. Networks 359 can be any of a wide variety of different types of networks such as the Internet, a cellular network, a wide area network (WAN), a local area network (LAN), a controller area network (CAN), a controller area network flexible data-rate (CAN FD), a near-field communication network, ethernet, or any of a wide variety of other networks.

FIG. 5 shows that one or more operators 361 can operate work machine 100. The operators 361 interact with operator interface mechanisms 218. In some examples, operator interface mechanisms 218 can each include joysticks, levers, a steering wheel, linkages, pedals, buttons, wireless devices (e.g., mobile computing devices, etc.), dials, keypads, a display device (including a display screen), user actuatable elements (such as icons, buttons, etc.) on a display device, a microphone and speaker (where speech recognition and speech synthesis are provided), among a wide variety of other types of control devices. Where a touch sensitive display system is provided, the operators 361 can interact with operator interface mechanisms 218 using touch gestures. Additionally, at least some of the operator interface mechanisms 218 can be used to present (e.g., display, audible presentation, haptic presentation, etc.) various information. The examples described above are provided as illustrative examples and are not intended to limit the scope of the present disclosure. Consequently, other types of operator interface mechanisms 218 can be used and are within the scope of the present disclosure.

In one example, an operator interface mechanism 218, such as a display device or other device, can include buttons (e.g., displayed buttons or physical buttons) for adjusting enabling and disabling active alignment system 215 (or functionality thereof) and for adjusting settings (e.g., sensitivity, aggressiveness, thresholds, etc.) of active alignment system 215. For example, active alignment system 215 is operable to automatically control work machine 100. By automatically, it is meant without manual involvement except perhaps to enable active alignment system 215 or functionality thereof such as through the buttons discussed above.

FIG. 5 also shows remote users 366 interacting with work machine 100 and remote computing systems 300 through user interface mechanisms 364 over networks 359. In some examples, user interface mechanisms 364 can include joysticks, levers, a steering wheel, linkages, pedals, buttons, wireless devices (e.g., mobile computing devices, etc.), dials, keypads, a display device (including a display screen), user actuatable elements (such as icons, buttons, etc.) on a display device, a microphone and speaker (where speech recognition and speech synthesis are provided), among a wide variety of other types of control devices. Where a touch sensitive display system is provided, the users 366 can interact with user interface mechanisms 364 using touch gestures. Additionally, at least some of the user interface mechanisms 364 can be used to present (e.g., display, audible presentation, haptic presentation, etc.) various information. The examples described above are provided as illustrative examples and are not intended to limit the scope of the present disclosure. Consequently, other types of user interface mechanisms 364 can be used and are within the scope of the present disclosure.

Remote computing systems 300 can be a wide variety of different types of systems, or combinations thereof. For example, remote computing systems 300 can be in a remote server environment. Further, remote computing systems 300 can be remote computing systems, such as mobile devices, a remote network, a farm manager system, a vendor system, or a wide variety of other remote systems.

In one example, work machine 100 can be controlled remotely by remote computing systems 300 or by remote users 366, or both. In some examples, operators 361 are on-board (e.g., in an operator compartment, such as a cab) the work machine 100. In some examples, operators 361 are remote from the work machine 100 and control the work machine 100 through one or more interface mechanisms (e.g. one or more of 218) which are remote from the work machine 100 but operatively coupled (e.g., communicatively coupled, such as over networks 359) to the work machine 100.

It will be understood that, in some examples, items in system 500 can be distributed in various ways, including ways that differ from the example shown in FIG. 5. For example, but not by limitation, active alignment system 215, shown in FIG. 5 as being disposed on work machine 100, can be located elsewhere, such as at one or more remote computing systems 300. In yet other examples, active alignment system 215 can be distributed across one or more of work machine 100 or a remote computing system 300. Thus, it will be understood that active alignment system 215 can be distributed across system 500 in various ways.

FIG. 6 is a block diagram that shows examples of some of the components of system 500 in more detail and information flow between the components.

As illustrated in FIG. 5, it can be seen that data stores 204 and data stores 304 or a combination thereof, can include as data (205 and 305 respectively), worksite data 601, historical data 602, sensor data 603, machine data 604, control data 605, machine alignment data 606, and can include various other data 610, including, but not limited to, other data described elsewhere herein. In some examples, where the data is located can depend on where active alignment system 215 (also called system 215) is located.

As shown in FIG. 6, active alignment system 215, includes one or more data processing systems 630, current header position identification system 632, current feeder-house (or attachment frame) position identification system 634, future terrain identification system 636, future header position prediction system 638, future feeder-house (or attachment frame) position prediction system 640, future alignment prediction system 642, proactive machine adjustment identification system 644, machine learning system 646, and various other items and functionality 648. Proactive machine adjustment identification system 644, itself, includes feeder-house (or attachment frame) adjustment identification system 652, header adjustment identification system 654, alignment adjustment identification system 655, and various other items and functionality 656. As will be described in more detail, active alignment system 215 is operable to generate one or more outputs 660.

Worksite data 601 can include data relative to the worksite (e.g., one or more fields) at which the work machine 100 performs an agricultural operation. Worksite data 601 can be in the form of overhead imagery or maps, or both, including or indicating values of one or more topographic characteristics of the terrain of the worksite, such as, but not limited to, elevation values, slope values, etc.

Historical data 602 can include data including or indicating values of one or more topographic characteristics of the terrain of the worksite, such as, but not limited to, elevation values, slope values, etc. Historical data 602 can be derived from data (e.g., sensor data) collected during one or more historical operations at the worksite, for example, but not by limitation, sensor data generated by geographic position sensors (e.g., the same as or similar to 203) and sensor data generated by machine orientation sensors (e.g., the same as or similar to 223) on agricultural work machines that performed historical operation at the worksite.

Sensor data 603 includes sensor data (e.g., images, sensor signals, etc.) generated by sensors 208, for example, observation sensor system sensor data generated by observation sensor systems 227, header position sensor data generate by header position sensors 226, heading/speed sensor data generated by heading/speed sensors 225, feeder-house position sensor data generated by feeder-house position sensors 224, machine orientation sensor data generated by machine orientation sensors 223, geographic position sensor data generated by geographic position sensors 203, as well as various other sensor data generated by other sensors 228.

Machine data 604 includes data indicative of dimensions and spatial relationships of the work machine 100, including dimensions of individual components of the work machine 100 and spatial relationships between individual components of the work machine 100. Machine data 604 can include data indicative of the range of motion of components of the work machine 100, such as a range of motion of an attachment assembly (e.g., 110). Machine data 604 can include data indicative of a location of a reference point on each of a plurality of components, relative to other components, for instance, a location of a reference point (e.g., 194) on an attachment frame or feeder-house relative to other components, including other components of the attachment frame or feeder-house, as well as a location of a reference point (e.g., 196) on a header relative to other components, including other components of the header. It will be understood that the machine data 604, with regard to location of reference points, refers to the location of the reference point on the particular component and its spatial relationship (e.g., distance from) other components of the work machine 100 and not the position of the reference point in 2D or 3D space at the worksite which is determined by other items of active alignment system 215, as discussed below. Machine data 604 can be provided in various ways, such as by user or operator input, from third parties (e.g., manufacturer, seller, etc.), as well as various other ways.

Control data 605 includes data indicative of various thresholds, various set-points, and various control outputs used in the control of work machine 100. For example, control data 605 can include header position targets or header position set-points. Control data 605 can include alignment (or relative positioning) targets indicating a desired alignment (or relative positioning) between a header and feeder-house (or attachment frame) of the work machine 100 or a desired alignment (or relative positioning) between a header reference point (e.g., 196) and a feeder-house (or attachment frame) reference point (e.g., 194). Control data 605 can include data indicative of adjustment to or operation of other components of the work machine 100, such as adjustment or operation of ground-engaging elements 160 which may affect the alignment (or relative positioning) between the header and the feeder-house. Control data 605 can be provided or adjusted by operator or user input. Control data 605 can be outputs (e.g., control signals) generated by a control system (e.g., 214). Control data 605 can be provided by various other sources, such as pre-set thresholds provided by a manufacturer or other third-party.

Machine alignment data 606 includes data useable by active alignment system 215 to identify (or predict) future positions of components and future alignments between components of work machine 100, such as future positions of a header (e.g., 104) (or a reference point (e.g., 196) thereof), future positions of a feeder-house (e.g., 106) or attachment frame (e.g., 111) (or a reference point (e.g., 194) thereof), and future alignments between a header and feeder-house or attachment frame (or future alignments between a reference point of the header and a reference point of the feeder-house or attachment frame). For example, machine alignment data 606 can include lookup tables, equations, models, as well as various other data useable to identify (or predict) future positions of components and future alignments between components of work machine 100, such as future positions of a header (e.g., 104), future positions of a feeder-house (e.g., 106) or attachment frame (e.g., 111), and future alignments between a header and feeder-house or attachment frame.

Data processing systems 630 process worksite data 601, historical data 602, sensor data 603, machine data 604, threshold data 605, machine alignment data 606, and other data 610 to generate processed data. The processed data can include computer readable values, useable (or readable) by other items of active alignment system 215. Data processing systems 630 can include various processing functionality, including image processing functionality, sensor signal processing functionality, filtering functionality, categorization functionality, normalization functionality, aggregation functionality, color extraction functionality, analog-to-digital conversion functionality, as well as various other data processing functionalities.

Current header position identification system 632 is operable to identify a current position of a header (e.g., 104) of work machine 100 based on one or more items of data 205/305. For example, current header position identification system 632 can identify a current position of a header of the work machine 100 based, at least, on sensor data 603 such as sensor data generated by header position sensors 226. In identifying a current position of a header of work machine 100, current header position identification system 632 can identify a current position of a reference point (e.g., 196) on the header, such as based on, at least, sensor data 603 (such as sensor data generated by header position sensors 226) as well as machine data 604 (e.g., indicative of the location of the reference point on the header).

Current feeder-house (or attachment frame) position identification system 634 is operable to identify a current position of a feeder-house (e.g., 106) or attachment frame (e.g., 111) of work machine 100 based on one or more items of data 205/305. For example, current feeder-house (or attachment frame) position identification system 634 is operable to identify a current position of a feeder-house or attachment frame of work machine 100 based on sensor data 603 such as sensor data generated by feeder-house position sensors 224. In identifying a current position of a feeder-house or attachment frame of work machine 100, current feeder-house (or attachment frame) position identification system 634 can identify a current position of a reference point (e.g., 194) on the feeder-house or attachment frame, such as based on, at least, sensor data 603 (such as sensor data generated by feeder-house position sensors 224) as well as machine data 604 (e.g., indicative of the location of the reference point on the feeder-house or attachment frame).

With regard to systems 632 and 634, the term current is used to indicate a current position determined in real time or near-real time. It will be understood by those skilled in the art that, given continuous movement of the work machine 100 and potential latency of the system 215 (e.g., processing time) that current position can refer to a position value based on the most recent data (e.g., sensor data) indicative of the position of the component (or reference point) of interest but that there may be a delay between when the position of the component (or reference point) is detected and when the position of the component (or reference point) is determined.

Future terrain identification system 636 is operable to identify future terrain (and topographic characteristics (e.g., elevation, slope, etc.) thereof) of the worksite at which work machine 100 operates based on one or more items of data 205/305. For example, future terrain identification system 636 can identify future terrain (and topographic characteristics thereof) based on worksite data 601, such as overhead imagery or maps, or both, including or indicating values of one or more topographic characteristics of the terrain of the worksite. In another example, future terrain identification system 636 can identify future terrain (and topographic characteristics thereof) based on historical data 602, such as sensor data generated during one or more historical operations at the worksite. In another example, future terrain identification system 636 can identify future terrain (and topographic characteristics thereof) based on sensor data 603, such as sensor data generated by observation sensor systems 227, By future terrain, it is meant terrain ahead of the work machine 100 relative to a travel direction or planned route of the work machine 100. Thus, it will be understood that future identification system 636 can identify elevation and slope of terrain ahead of the work machine 100.

Future header position prediction system 638 is operable to identify (e.g., predict) a future position of a header (e.g., 104) of work machine 100 based on one or more items of data 205/305. For example, future header position identification system 638 can identify a future position of a header of the work machine 100 based, at least, on future terrain data (e.g., topographic characteristics of future terrain) as identified by future terrain identification system 636, as well as, for instance, control data 605 (e.g., control data indicative of the header position set-point), machine data 604, and machine alignment data 606. In identifying a future position of a header of work machine 100, future header position identification system 638 can identify a future position of a reference point (e.g., 196) on the header, such as based on, at least, future terrain data (e.g., topographic characteristics of future terrain) as identified by future terrain identification system 636, as well as machine data 604 (e.g., indicative of the location of the reference point on the header), control data 605 (e.g., control data indicative of the header position set-point), and machine alignment data 606.

Future feeder-house (or attachment frame) position identification system 640 is operable to identify (e.g., predict) a future position of a feeder-house (e.g., 106) or attachment frame (e.g., 111) of work machine 100 based on one or more items of data 205/305. For example, future feeder-house (or attachment frame) position identification system 640 is operable to identify a future position of a feeder-house or attachment frame of work machine 100 based, at least, on future terrain data (e.g., topographic characteristics of future terrain) as identified by future terrain identification system 636 as well as machine data 604 and machine alignment data 606. In identifying a future position of a feeder-house or attachment frame of work machine 100, future feeder-house (or attachment frame) position identification system 640 can identify a future position of a reference point (e.g., 194) on the feeder-house or attachment frame, such as based on, at least, on future terrain data (e.g., topographic characteristics of future terrain) as identified by future terrain identification system 636, as well as machine data 604 (e.g., indicative of the location of the reference point on the feeder-house or attachment frame) and machine alignment data 606.

Future alignment prediction system 642 is operable to identify (e.g., predict) a future alignment (relative positioning) between a header (e.g., 104) and feeder-house (e.g., 106) or attachment frame (e.g., 111) of work machine 100 based, at least, on a future header position output by future header position identification system 638 and a future feeder-house (or attachment frame) position output by future feeder-house (or attachment frame) position identification system 640, as well as machine alignment data 606. In identifying a future alignment (relative positioning) between the header and the feeder-house (or attachment frame), future alignment prediction system 642 can identify a future alignment (relative positioning) between a reference point (e.g., 196) on the header and a reference point (e.g., 194) on the feeder-house (or attachment frame) based, at least, on a future header reference point position output by future header position identification system 638 and a future feeder-house (or attachment frame) reference point position output by future feeder-house (or attachment frame) position identification system 640, as well as machine alignment data 606.

Proactive machine adjustment identification system 644 is operable to identify proactive adjustments to the work machine 100 based on a future alignment (relative positioning) between a header and feeder-house (or attachment frame) (or a future alignment (relative positioning) between a reference point of a header and a reference point of a feeder-house (or attachment frame)) as identified by future alignment prediction system 642 as well as control data 605 (e.g., target alignment (or relative positioning) between a header and feeder-house (or attachment frame), target alignment (or relative positioning) between a header reference point (e.g., 196) and a feeder-house (or attachment frame) reference point (e.g., 196), ground-engaging element 160 set-points, adjustment, control, etc.). For example, proactive machine adjustment identification system 644 can compare a future alignment (or relative positioning) output by future alignment prediction system 642 to a target alignment (or relative positioning) of control data 605 and, based on the comparison, identify proactive adjustments of the work machine. For instance, proactive machine adjustment identification system 644 can, based on upcoming terrain (and the corresponding predicted positions of feeder-house and header (or attachment frame), and thus, the alignment (or relative positioning) therebetween) proactively control the work machine 100 to maintain a desired (or target) alignment (or relative positioning) between the header and feeder-house (or attachment frame) at the upcoming terrain. In other examples, proactive machine adjustment system 644 can, based on upcoming terrain (and the corresponding predicted positions of feeder-house and header (or attachment frame), and thus, the alignment (or relative positioning) therebetween) can also make adjustments to the desired (or target) alignment (or relative positioning) between the header and the feeder-house (or attachment frame). For instance, based on upcoming terrain, proactive machine adjustment identification system 644 can identify a new desired (or target) alignment (or relative positioning) between the header and the feeder-house (or attachment frame).

Feeder-house (or attachment frame) adjustment identification system 652 is operable to identify a feeder-house (or attachment frame) adjustment, such as feeder-house (or attachment frame) position adjustment based on a future alignment (or relative positioning) output by future alignment prediction system 642, as well as, in some examples, a target alignment (or relative positioning) of control data 605. The adjustment identified by feeder-house (or attachment frame) adjustment identification system 652 can include a target feeder-house (or attachment frame) position or a target feeder-house (or attachment frame) reference point (e.g., 194) position.

Header adjustment identification system 654 is operable to identify a header adjustment, such as header position adjustment based on a future alignment (or relative positioning) output by future alignment prediction system 642, as well as, in some examples, a target alignment (or relative positioning) of control data 605. The adjustment identified by header adjustment identification system 654 can include a target header position or a target header reference point (e.g., 196) position.

Alignment adjustment identification system 655 is operable to identify an alignment (or relative positioning) adjustment that defines a new (or adjusted) desired (or target) alignment (or relative positioning) between the header and the feeder-house (or attachment frame) based on the outputs of one or more items of system 215 as well as one or more items of data 205/305. The alignment (or relative positioning) adjustment identified by alignment adjustment identification system 655 can include a target alignment (or relative positioning) which can define target feeder-house (or attachment frame) position or a target feeder-house (or attachment frame) reference point position and a target header position or a target header reference point position. Thus, the alignment (or relative positioning) adjustment identified by alignment adjustment identification system 655 can be used by feeder-house (or attachment frame) adjustment identification system 652 to identify a feeder-house (or attachment frame) adjustment and by header adjustment identification system 654 to identify a header adjustment. It will be understood that a desired (or target) alignment can be a value or a set of values defining a desired (or target) alignment (or relative positioning) between the header and the feeder-house (or attachment frame) (or between the corresponding reference points thereof).

In some examples, it may be that both the header and the feeder-house (or attachment frame) are adjusted (e.g., position adjusted). In some examples, it may be that only one of the header or the feeder-house (or attachment frame) is adjusted (e.g., position adjusted). It will be understood that the adjustments identified by proactive machine adjustment identification system 644 can be identified (and executed) proactively such that the alignment (or relative positioning) between the header and the feeder-house (or attachment frame) or the alignment (or relative positioning) between the header reference point and the feeder-house (or attachment frame) reference point is at (or at least closer to) a desired (or target) alignment (or relative positioning) when the work machine 100 operates at the future terrain.

Machine learning system 646 is operable to execute machine learning functionality to update (e.g., relearn) data (e.g., machine alignment data 606) used in the prediction of future positions and alignments based on sensor data 603. For example, machine learning system 646 may utilize predicted positions and alignments for future areas of the worksite and sensor data 603 indicative of actual positions and alignments at those future areas to update (e.g., relearn) data (e.g., machine alignment data 606) used in the prediction of future positions and alignments. This can include identifying and applying calibration values, identifying and applying offset values, updating a model or function, as well as various other updating. In this way, the operation of active alignment system 215 can improve throughout the course of an operation and throughout the course of multiple operations. The learning (or updating) can be implemented during the course of the operation such that updated data (e.g., updated machine alignment data 606) is generated and used throughout the course of an operation.

Machine learning system 646 is operable to execute machine learning functionality to verify and improve proactive machine adjustments identified by proactive machine adjustment identification system 644 based on one or more items of data 205/305. For example, machine learning system 646 is operable to detect material flow characteristics of material after adjustment(s) output by proactive machine adjustment identification system 644 are instituted to determine the impact of the adjustments on the performance of the machine (e.g., the impact of the adjustments on material flow performance). For example, machine learning system 646 is operable to determine whether adjustment(s) result in acceptable (e.g., relative to a threshold, etc.) material flow and can thereby determine which adjustment(s) (e.g., alignments (or relative positionings, etc.) are acceptable and which are not. This learning can be conducted throughout the course of an operation to continuously learn and improved adjustments throughout the course of the operation. This learning can be stored such that it can be utilized in future operations. This learning can be output and utilized by proactive machine adjustment identification system 644 in identifying future adjustments.

As can be seen, active alignment system 215 is operable to generate, based on one or more items of data 205/305, one or more active alignment outputs 660 (also referred to herein as outputs 660). Outputs 660 can include one or more current header positions (or current header reference point positions), one or more future header positions (or future header reference point positions), one or more current feeder-house (or attachment frame) positions (or current feeder-house (or attachment frame) reference point positions), one or more future feeder-house (or attachment frame) positions (or future feeder-house (or attachment frame) reference point positions), one or more future alignments (or relative positionings) between a header and feeder-house (or attachment frame) (or future alignments (or relative positionings) between a header reference point and a feeder-house (or attachment frame) reference point), one or more feeder-house (or attachment frame) adjustments, one or more header adjustments, one or more alignment (or relative positioning) adjustments, as well as other items or information.

The outputs 660 can be provided to a control system 214 for controlling items of a work machine, such as one or more controllable subsystems 216 or one or more interface mechanisms 218 (e.g., to generate presentations, such as displays, based on or indicative of the outputs 660), as well as other items of a work machine. For example, but not by limitation, an output 660, such as a feeder-house (or attachment frame) adjustment can be provided to control system 214 to control one or more feeder-house position actuators 250 to adjust the position of a feeder-house (or attachment frame). In another example, but not by limitation, an output 660, such as a header adjustment can be provided to control system 214 to control one or more header position actuators 252 to adjust the position of a header. For example, but not by limitation, an output 660, such as an alignment (or relative positioning) adjustment can be provided to control system 214 to control one or more feeder-house position actuators 250 to adjust the position of a feeder-house (or attachment frame) or to control one or more header position actuators 252 to adjust the position of a header, or both.

The outputs 660 can be provided to various other items 362 of system 500, such as one or more interface mechanisms 364 (e.g., to generate presentations, such as displays, based on or indicative of the outputs 660).

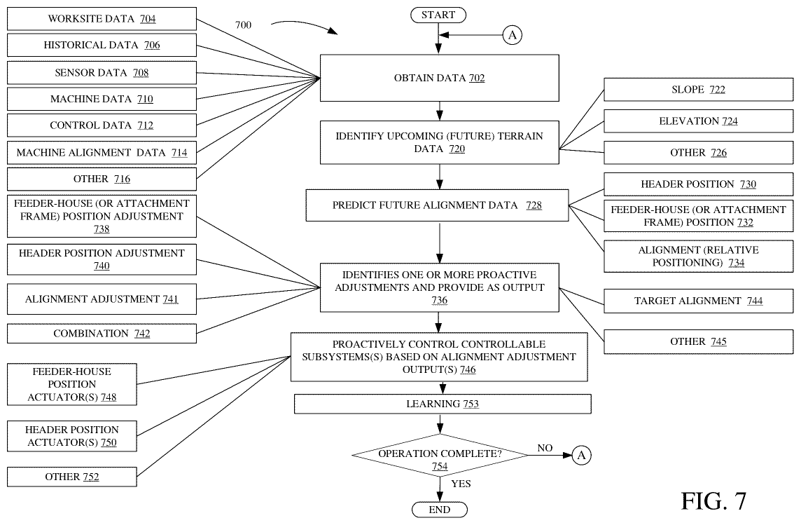

FIG. 7 shows a flow diagram illustrating an example operation 700 of agricultural system 500 in performing active alignment control.

At block 702, active alignment system 215 obtains one or more items of data. As indicated by block 704, the one or more items of data can include worksite data 601. As indicated by block 706, the one or more items of data can include historical data 602. As indicated by block 708, the one or more items of data can include sensor data 603. As indicated by block 710, the one or more items of data can include machine data 604. As indicated by block 712, the one or more items of data can include control data 605. As indicated by block 714, the one or more items of data can include machine alignment data 606. As indicated by block 716, the one or more items of data can include various other data 610.

At block 720, active alignment system 215 (e.g., future terrain identification system 636) identifies upcoming (or future) terrain data (e.g., upcoming (or future) terrain and one or more topographic characteristics thereof) based, at least, on one or more items of the obtained data at block 702. As previously discussed, upcoming (or future) terrain refers to terrain at the worksite ahead of the work machine 100 relative to a travel direction or planned route of the work machine 100. As indicated by block 722, the one or more topographic characteristics of upcoming (or future) terrain can include slope. As indicated by block 724, the one or more topographic characteristics of upcoming (or future) terrain can include elevation. As indicated by block 726, the one or more topographic characteristics of upcoming (or future) terrain can include other topographic characteristics. Some examples of identifying upcoming (or future) terrain are described in FIG. 6. For example, but not by limitation, active alignment system 215 (e.g., future terrain identification system 636) can identify upcoming (or future) terrain and one or more topographic characteristics thereof based on worksite data 601, historical data 602, or sensor data 603.

At block 728, active alignment system 215 (e.g., future header position prediction system 638, future feeder-house (or attachment frame) position prediction system 640, and future alignment prediction system 642) identifies (e.g., predicts) future alignment data based, at least, on the identified upcoming (or future) terrain data identified at block 720. As indicated by block 730, future alignment data can include a future header (e.g., 104) or a future header reference point (e.g., 196) position. As indicated by block 732, future alignment data can include a future feeder-house (e.g., 106) or attachment frame (e.g., 111) position or future feeder-house (or attachment frame) reference point (e.g., 194) position. As indicated by block 734, future alignment data can include a future alignment (or relative positioning) between a header (e.g., 104) and feeder-house (e.g., 106) or attachment frame (e.g., 111) or a future alignment (or relative positioning) between a header reference point (e.g., 196) and a feeder-house (or attachment frame) reference point (e.g., 194). Some examples of identifying future alignment data are described in FIG. 6.

For example, but not by limitation, a future header position can be identified (e.g., predicted) based on the identified upcoming (or future) terrain data, as well as machine data 604, control data 605, and machine alignment data 606. For example, but not by limitation, a future header reference point position can be identified (e.g., predicted) based on the identified upcoming (or future) terrain data, as well as machine data 604, control data 605, and machine alignment data 606.

For example, but not by limitation, a future feeder-house (or attachment frame) position can be identified (e.g., predicted) based on the identified upcoming (or future) terrain data as well as machine data 604 and machine alignment data 606. For example, but not by limitation, a future feeder-house (or attachment frame) reference point position can be identified (e.g., predicted) based on the identified upcoming (or future) terrain data, as well as machine data 604 and machine alignment data 606.

For example, but not by limitation, a future alignment (or relative positioning) between the header and the feeder-house (or attachment frame) can be identified (e.g., predicted) based on an identified future position of the header and an identified future position of the feeder-house (or attachment frame). For example, but not by limitation, a future alignment (or relative positioning) between the header reference point and the feeder-house (or attachment frame) reference point can be identified (e.g., predicted) based on an identified future position of the header reference point and an identified future position of the feeder-house (or attachment frame) reference point.

At block 736, active alignment system 215 (e.g., proactive machine adjustment identification system 644) identifies one or more proactive adjustments based, at least, on the future alignment data identified (e.g., predicted) at block 728 or on upcoming (future) terrain identified at block 720, or both. At block 736, active alignment system 215 generates the one or more proactive adjustments as outputs 660. As indicated by block 738 the one or more proactive adjustments can include an identified feeder-house (or attachment frame) position adjustment, which can include a target feeder-house (or attachment frame) position. As indicated by block 740, the one or more proactive adjustments can include an identified header position adjustment, which can include a target header position. As indicated by block 741, the one or more proactive adjustments can include an identified alignment (or relative positioning) adjustment, which can include an adjusted target (or desired) alignment (or relative positioning) between the header and the feeder-house (or attachment frame). As indicated by block 742, the one or more proactive adjustments can include a combination of a feeder-house (or attachment frame) position adjustment, a header position adjustment, and an alignment (or relative positioning) adjustment. As indicated by block 744, identifying the one or more proactive adjustments can include identifying the one or more proactive adjustments (e.g., header position adjustment, feeder-house (or attachment frame) position adjustment) based on a target (or threshold) alignment (or relative positioning) between the header and the feeder-house (or attachment frame) or a target (or threshold) alignment (or relative positioning) between the header reference point and the feeder-house (or attachment frame) reference point. As previously explained, control data 605 can include target (or threshold) alignments (or relative positionings). As indicated by block 745, identifying the one or more proactive adjustments can include identifying the one or more proactive adjustments based on one or more items of data 205/305 or based on other information identified by system 215, or both, for example, but not by limitation, based on learning outputs generated by system 215 (e.g., machine learning system 646). Some examples of identifying one or more proactive adjustments are described in FIG. 6.

At block 746, system 500 (e.g., control system 214) proactively controls one or more controllable subsystems 216 based on the one or more identified proactive adjustments identified at block 736. The one or more identified proactive adjustments identified at block 736 can be output by active alignment system 215 as outputs 660 and provided to other items of system 500, such as control system 214. As indicated by block 748, system 500 (e.g., control system 214) can generate control signals to control one or more feeder-house position actuators 250 based on an identified proactive adjustment (e.g., an identified feeder-house (or attachment frame) position adjustment or an identified alignment (or relative positioning) adjustment). As indicated by block 750, system 500 (e.g., control system 214) can, additionally, or alternatively, generate control signals to control one or more header position actuators 252 based on an identified proactive adjustment (e.g., an identified header position adjustment or an identified alignment (or relative positioning) adjustment). As indicated by block 752, system 500 (e.g., control system 214) can control other controllable subsystems based on the one or more identified proactive adjustments.

At block 753, system 215 (e.g., machine learning system 646) executes machine learning functionality based on the executed proactive adjustments and one or more other items of data 205/305, such as observation sensor data generated by observation sensors 227 indicative of material flow characteristics, to generate learning outputs indicative of the effectiveness or acceptability of the proactive adjustments. For example, system 215 can determine whether or not the proactive adjustments result in acceptable material flow and generate learning outputs indicative of that determination. The learning outputs can be used in future generation of proactive adjustments (e.g., can be used at block 745).

At block 754, it is determined if the operation 700 is complete (e.g., work machine 100 finished operating at worksite, active alignment system 215 deactivated, etc.). If, at block 754, it is determined that the operation 700 is not complete, then processing returns to block 702. If, at block 754, it is determined that the operation 700 is complete, then processing ends (at least until work machine 100 begins operating again at the worksite or another worksite or until active alignment system 215 is activated).

The present discussion has mentioned processors and servers. In some examples, the processors and servers include computer processors with associated memory and timing circuitry, not separately shown. They are functional parts of the systems or devices to which they belong and are activated by and facilitate the functionality of the other components or items in those systems.

Also, a number of user interface displays have been discussed. The displays can take a wide variety of different forms and can have a wide variety of different user actuatable operator interface mechanisms disposed thereon. For instance, user actuatable operator interface mechanisms can include text boxes, check boxes, icons, links, drop-down menus, search boxes, etc. The user actuatable operator interface mechanisms can also be actuated in a wide variety of different ways. For instance, they can be actuated using operator interface mechanisms such as a point and click device, such as a track ball or mouse, hardware buttons, switches, a joystick or keyboard, thumb switches or thumb pads, etc., a virtual keyboard or other virtual actuators. In addition, where the screen on which the user actuatable operator interface mechanisms are displayed is a touch sensitive screen, the user actuatable operator interface mechanisms can be actuated using touch gestures. Also, user actuatable operator interface mechanisms can be actuated using speech commands using speech recognition functionality. Speech recognition can be implemented using a speech detection device, such as a microphone, and software that functions to recognize detected speech and execute commands based on the received speech.

A number of data stores have also been discussed. It will be noted the data stores can each be broken into multiple data stores. In some examples, one or more of the data stores can be local to the systems accessing the data stores, one or more of the data stores can all be located remote form a system utilizing the data store, or one or more data stores can be local while others are remote. All of these configurations are contemplated by the present disclosure.

Also, the figures show a number of blocks with functionality ascribed to each block. It will be noted that fewer blocks can be used to illustrate that the functionality ascribed to multiple different blocks is performed by fewer components. Also, more blocks can be used illustrating that the functionality can be distributed among more components. In different examples, some functionality can be added, and some can be removed.

It will be noted that the above discussion has described a variety of different systems, controllers, components, and interactions. It will be appreciated that any or all of such systems, controllers, components, and interactions can be implemented by hardware items, such as one or more processors, one or more processors executing computer executable instructions stored in memory, memory, or other processing components, some of which are described below, that perform the functions associated with those systems, controllers, components, and interactions. In addition, any or all of the systems, controllers, components, and interactions can be implemented by software that is loaded into a memory and is subsequently executed by one or more processors or one or more servers or other computing component(s), as described below. Any or all of the systems, controllers, components, and interactions can also be implemented by different combinations of hardware, software, firmware, etc., some examples of which are described below. These are some examples of different structures that can be used to implement any or all of the systems, controllers, components, and interactions described above. Other structures can be used as well.

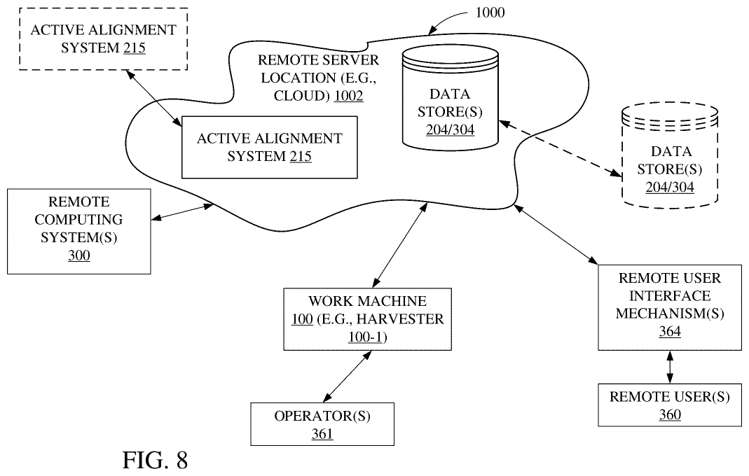

FIG. 8 is a block diagram of a remote server architecture 1000. FIG. 8, also shows work machine 100, one or more remote computing systems 300, and one or more remote user interface mechanisms 364, in communication with the remote server environment. The work machine 100, remote computing systems 300, and remote user interface mechanisms 364 communicate with elements in a remote server architecture 1000. In some examples, remote server architecture 1000 provides computation, software, data access, and storage services that do not require end-user knowledge of the physical location or configuration of the system that delivers the services. In various examples, remote servers can deliver the services over a wide area network, such as the internet, using appropriate protocols. For instance, remote servers can deliver applications over a wide area network and can be accessible through a web browser or any other computing component. Software or components shown in previous figures as well as data associated therewith, can be stored on servers at a remote location. The computing resources in a remote server environment can be consolidated at a remote data center location, or the computing resources can be dispersed to a plurality of remote data centers. Remote server infrastructures can deliver services through shared data centers, even though the services appear as a single point of access for the user. Thus, the components and functions described herein can be provided from a remote server at a remote location using a remote server architecture. Alternatively, the components and functions can be provided from a server, or the components and functions can be installed on client devices directly, or in other ways.

In the example shown in FIG. 8, some items are similar to those shown in previous figures and those items are similarly numbered. FIG. 8 specifically shows that active alignment system 215, data stores 204, or data stores 304 or a combination thereof, can be located at a server location 1002 that is remote from the work machine 100, remote computing systems 300, and remote user interface mechanisms 364. Therefore, in the example shown in FIG. 8, work machine 100, remote computing systems 300, and remote user interface mechanisms 364 access systems through remote server location 1002. In other examples, various other items can also be located at server location 1002, such as various other items of agricultural system architecture 500.

FIG. 8 also depicts another example of a remote server architecture. FIG. 8 shows that some elements of previous figures can be disposed at a remote server location 1002 while others can be located elsewhere. By way of example, one or more of data store(s) 204 or 304 can be disposed at a location separate from location 1002 and accessed via the remote server at location 1002. Similarly, active alignment system 215 can be disposed at a location separate from location 1002 and accessed via the remote server at location 1002. Regardless of where the elements are located, the elements can be accessed directly by work machine 100, remote computing systems 300, and remote user interface mechanisms 364 through a network such as a wide area network or a local area network; the elements can be hosted at a remote site by a service; or the elements can be provided as a service or accessed by a connection service that resides in a remote location. Also, data can be stored in any location, and the stored data can be accessed by, or forwarded to, operators, users, or systems. For instance, physical carriers can be used instead of, or in addition to, electromagnetic wave carriers. In some examples, where wireless telecommunication service coverage is poor or nonexistent, another machine, such as a fuel truck or other mobile machine or vehicle, can have an automated, semi-automated or manual information collection system. As a mobile machine (e.g., work machine 100) comes close to the machine containing the information collection system, such as a fuel truck prior to fueling, or other mobile machine or vehicle, the information collection system collects the information from the mobile machine (e.g., work machine 100) using any type of ad-hoc wireless connection. The collected information can then be forwarded to another network when the machine containing the received information reaches a location where wireless telecommunication service coverage or other wireless coverage is available. For instance, a fuel truck, can enter an area having wireless communication coverage when traveling to a location to fuel other machines or when at a main fuel storage location. Other mobile machines or vehicles can enter an area having wireless communication coverage when traveling to other locations or when at another location. All of these architectures are contemplated herein. Further, the information can be stored on a mobile machine (e.g., work machine 100) until the mobile machine enters an area having wireless communication coverage. The mobile machine (e.g., work machine 100), itself, can send the information to another network.

It will also be noted that the elements of previous figures, or portions thereof, can be disposed on a wide variety of different devices. One or more of those devices can include an on-board computer, an electronic control unit, a display unit, a server, a desktop computer, a laptop computer, a tablet computer, or other mobile device, such as a palm top computer, a cell phone, a smart phone, a multimedia player, a personal digital assistant, etc.

In some examples, remote server architecture 1000 can include cybersecurity measures. Without limitation, these measures can include encryption of data on storage devices, encryption of data sent between network nodes, authentication of people or processes accessing data, as well as the use of ledgers for recording metadata, data, data transfers, data accesses, and data transformations. In some examples, the ledgers can be distributed and immutable (e.g., implemented as blockchain).

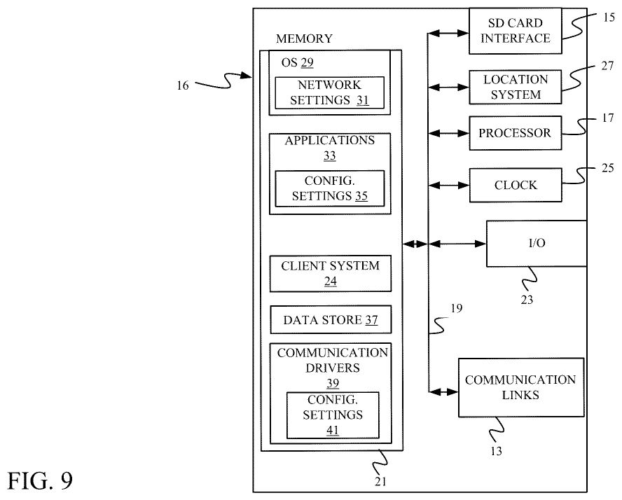

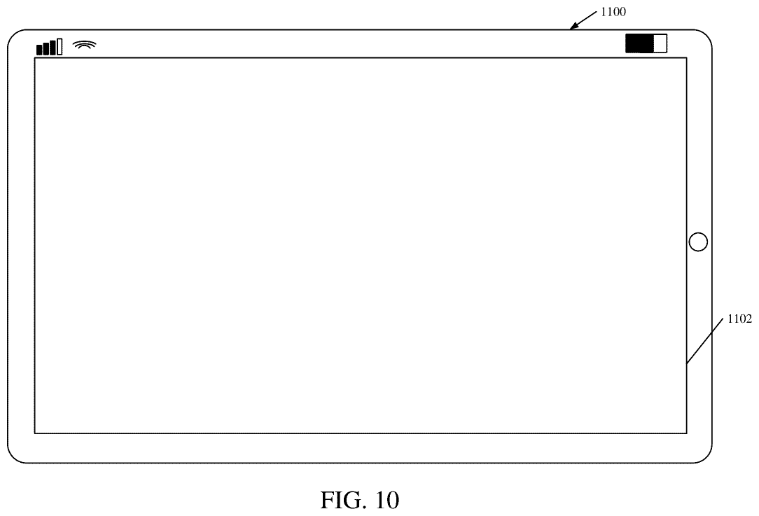

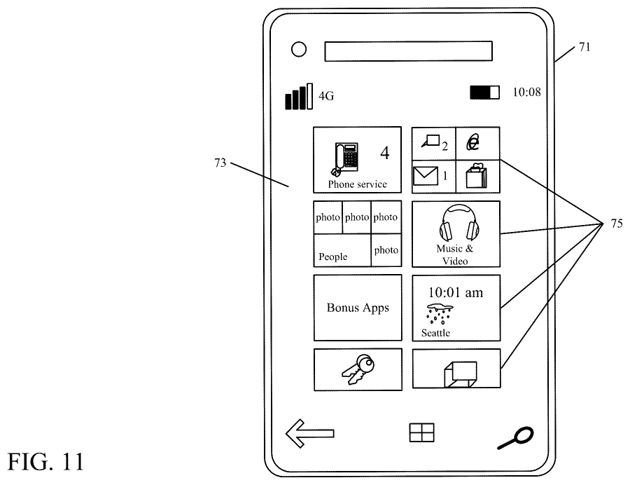

FIG. 9 is a simplified block diagram of one illustrative example of a handheld or mobile computing device that can be used as a user's or client's handheld device 16, in which the present system (or parts of it) can be deployed. For instance, a mobile device can be deployed in the operator compartment of a mobile machine (e.g., work machine 100) or can be communicably coupled to a mobile machine (e.g., work machine 100) for use in generating, processing, or displaying the outputs (e.g., 660) discussed above. FIGS. 10 and 11 are examples of handheld or mobile devices.

FIG. 9 provides a general block diagram of the components of a client device 16 that can run some components shown in previous figures, that interacts with them, or both. In the device 16, a communications link 13 is provided that allows the handheld device to communicate with other computing devices and under some examples provides a channel for receiving information automatically, such as by scanning. Examples of communications link 13 include allowing communication though one or more communication protocols, such as wireless services used to provide cellular access to a network, as well as protocols that provide local wireless connections to networks.

In other examples, applications can be received on a removable Secure Digital (SD) card that is connected to an interface 15. Interface 15 and communication links 13 communicate with a processor 17 (which can also embody processors or servers from other figures) along a bus 19 that is also connected to memory 21 and input/output (I/O) components 23, as well as clock 25 and location system 27.

I/O components 23, in one example, are provided to facilitate input and output operations. I/O components 23 for various examples of the device 16 can include input components such as buttons, touch sensors, optical sensors, microphones, touch screens, proximity sensors, accelerometers, orientation sensors and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. Location system 27 can also include, for example, mapping software or navigation software that generates desired maps, navigation routes and other geographic functions.

Memory 21 stores operating system 29, network settings 31, applications 33, application configuration settings 35, client system 24, data store 37, communication drivers 39, and communication configuration settings 41. Memory 21 can include all types of tangible volatile and non-volatile computer-readable memory devices. Memory 21 can also include computer storage media (described below). Memory 21 stores computer readable instructions that, when executed by processor 17, cause the processor to perform computer-implemented steps or functions according to the instructions. Processor 17 can be activated by other components to facilitate their functionality as well.

FIG. 10 shows one example in which device 16 is a tablet computer 1100. In FIG. 10, computer 1100 is shown with user interface display screen 1102. Screen 1102 can be a touch screen or a pen-enabled interface that receives inputs from a pen or stylus. Tablet computer 1100 can also use an on-screen virtual keyboard. Of course, computer 1100 can also be attached to a keyboard or other user input device through a suitable attachment mechanism, such as a wireless link or USB port, for instance. Computer 1100 can also illustratively receive voice inputs as well.

FIG. 11 is similar to FIG. 10 except that the device is a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

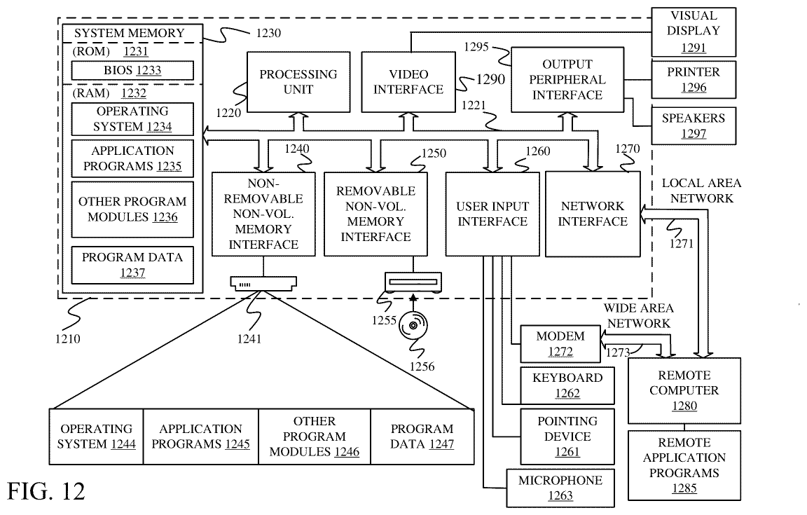

FIG. 12 is one example of a computing environment in which elements of previous figures described herein can be deployed. With reference to FIG. 12, an example system for implementing some embodiments includes a computing device in the form of a computer 1210 programmed to operate as discussed above. Components of computer 1210 can include, but are not limited to, a processing unit 1220 (which can comprise processors or servers from previous figures), a system memory 1230, and a system bus 1221 that couples various system components including the system memory to the processing unit 1220. The system bus 1221 can be any of several types of bus structures including a memory bus or memory controller, a peripheral bus, and a local bus using any of a variety of bus architectures. Memory and programs described with respect to previous figures described herein can be deployed in corresponding portions of FIG. 12.

Computer 1210 typically includes a variety of computer readable media. Computer readable media can be any available media that can be accessed by computer 1210 and includes both volatile and nonvolatile media, removable and non-removable media. By way of example, and not limitation, computer readable media can comprise computer storage media and communication media. Computer storage media is different from, and does not include, a modulated data signal or carrier wave. Computer readable media includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 1210. Communication media can embody computer readable instructions, data structures, program modules or other data in a transport mechanism and includes any information delivery media. The term “modulated data signal” means a signal that has one or more of its characteristics set or changed in such a manner as to encode information in the signal.

The system memory 1230 includes computer storage media in the form of volatile and/or nonvolatile memory or both such as read only memory (ROM) 1231 and random access memory (RAM) 1232. A basic input/output system 1233 (BIOS), containing the basic routines that help to transfer information between elements within computer 1210, such as during start-up, is typically stored in ROM 1231. RAM 1232 typically contains data or program modules or both that are immediately accessible to and/or presently being operated on by processing unit 1220 or both immediately accessible to and presently being operated on by the processing unit 1220. By way of example, and not limitation, FIG. 12 illustrates operating system 1234, application programs 1235, other program modules 1236, and program data 1237.

The computer 1210 can also include other removable/non-removable volatile/nonvolatile computer storage media. By way of example only, FIG. 12 illustrates a hard disk drive 1241 that reads from or writes to non-removable, nonvolatile magnetic media, an optical disk drive 1255, and nonvolatile optical disk 1256. The hard disk drive 1241 is typically connected to the system bus 1221 through a non-removable memory interface such as interface 1240, and optical disk drive 1255 are typically connected to the system bus 1221 by a removable memory interface, such as interface 1250.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (e.g., ASICs), Application-specific Standard Products (e.g., ASSPs), System-on-a-chip systems (SOCs), Complex Programmable Logic Devices (CPLDs), quantum computers, etc.

The drives and their associated computer storage media discussed above and illustrated in FIG. 12, provide storage of computer readable instructions, data structures, program modules and other data for the computer 1210. In FIG. 12, for example, hard disk drive 1241 is illustrated as storing operating system 1244, application programs 1245, other program modules 1246, and program data 1247. Note that these components can either be the same as or different from operating system 1234, application programs 1235, other program modules 1236, and program data 1237.

A user can enter commands and information into the computer 1210 through input devices such as a keyboard 1262, a microphone 1263, and a pointing device 1261, such as a mouse, trackball or touch pad. Other input devices (not shown) can include a joystick, game pad, satellite dish, scanner, or the like. These and other input devices are often connected to the processing unit 1220 through a user input interface 1260 that is coupled to the system bus, but can be connected by other interface and bus structures. A visual display 1291 or other type of display device is also connected to the system bus 1221 via an interface, such as a video interface 1290. In addition to the monitor, computers can also include other peripheral output devices such as speakers 1297 and printer 1296, which can be connected through an output peripheral interface 1295.

The computer 1210 is operated in a networked environment using logical connections (such as a controller area network—CAN, local area network—LAN, or wide area network WAN) to one or more remote computers, such as a remote computer 1280.

When used in a LAN networking environment, the computer 1210 is connected to the LAN 1271 through a network interface or adapter 1270. When used in a WAN networking environment, the computer 1210 typically includes a modem 1272 or other systems for establishing communications over the WAN 1273, such as the Internet. In a networked environment, program modules can be stored in a remote memory storage device. FIG. 12 illustrates, for example, that remote application programs 1285 can reside on remote computer 1280.

It should also be noted that the different examples described herein can be combined in different ways. That is, parts of one or more examples can be combined with parts of one or more other examples. All of this is contemplated herein.

Although the subject matter has been described in language specific to structural features, methodological acts, or both, it is to be understood that the subject matter defined in the appended claims is not necessarily limited to the specific features or acts described above. Rather, the specific features and acts described above are disclosed as example forms of the claims.

What is claimed IS:

1. An agricultural harvester comprising:
a header;
a feeder-house;
one or more processors; and
memory storing instructions, executable by the one or more processors, that, when executed by the one or more processors, cause the one or more processors to:
identify one or more topographic characteristics of upcoming terrain at a worksite based on data indicative of the one or more topographic characteristics of the upcoming terrain at the worksite;
identify a future alignment between the header and the feeder-house at the upcoming terrain at the worksite based, at least, on the identified one or more topographic characteristics of the upcoming terrain at the worksite;
identify one or more adjustments based on the identified future alignment between the header and the feeder-house at the upcoming terrain at the worksite; and
control one or more controllable subsystems of the agricultural harvester based on the identified one or more adjustments.

2. The agricultural harvester of claim 1 and further comprising an attachment frame coupled to the feeder-house and moveable control arms coupled to the attachment frame and the header, wherein the future alignment between the header and the feeder-house comprises a future alignment between a reference point on the header and a reference point on the attachment frame.

3. The agricultural harvester of claim 1, wherein the data indicative of the one or more topographic characteristics comprises one of:
overhead imagery of the worksite;
a map of the worksite;
data generated during a historical operation at the worksite; or
sensor data generated by an observation sensor system on the agricultural harvester.

4. The agricultural harvester of claim 1, wherein the one or more adjustments include a feeder-house position adjustment, wherein the one or more controllable subsystems include one or more feeder-house position actuators, and wherein the instructions, when executed by the one or more processors, cause the one or more processors to control the one or more feeder-house position actuators based on the feeder-house position adjustment.

5. The agricultural harvester of claim 1, wherein the one or more adjustments include a header position adjustment, wherein the one or more controllable subsystems include one or more header position actuators, and wherein the instructions, when executed by the one or more processors, cause the one or more processors to control the one or more header position actuators based on the header position adjustment.

6. The agricultural harvester of claim 1, wherein the one or more adjustments include a feeder-house position adjustment and a header position adjustment, wherein the one or more controllable subsystems include one or more feeder-house position actuators and one or more header position actuators, and wherein the instructions, when executed by the one or more processors, cause the one or more processors to control the one or more feeder-house position actuators based on the feeder-house position adjustment and to control the one or more header position actuators based on the header position adjustment.

7. The agricultural harvester of claim 1, wherein the one or more adjustments include an alignment adjustment that indicates an adjusted target alignment between the header and the feeder-house, wherein the one or more controllable subsystems include one or more actuators operable to adjust alignment between the header and the feeder-house, and wherein the instructions, when executed by the one or more processors, cause the one or more processors to control the one or more actuators based on the alignment adjustment.

8. The agricultural harvester of claim 1, wherein the instructions, when executed by the one or more processors, further cause the one or more processors to:
compare the identified future alignment between the header and the feeder-house at the upcoming terrain at the worksite to a target alignment between the header and the feeder-house; and
identify the one or more adjustments based on the comparison between the identified future alignment between the header and the feeder-house at the upcoming terrain at the worksite and the target alignment between the header and the feeder-house.

9. A computer implemented method of controlling an agricultural harvester, the computer implemented method comprising:
obtaining data relative to upcoming terrain at a worksite;
identifying one or more topographic characteristics of upcoming terrain at the worksite based on the data;
identifying a future alignment between a header of the agricultural harvester and a feeder-house of the agricultural harvester at the upcoming terrain at the worksite based, at least, on the identified one or more topographic characteristics of the upcoming terrain at the worksite;
identifying one or more adjustments based on the identified future alignment between the header and the feeder-house at the upcoming terrain at the worksite; and
controlling one or more controllable subsystems of the agricultural harvester based on the identified one or more adjustments.

10. The computer implemented method of claim 9, wherein identifying the future alignment comprises identifying a future alignment between a reference point corresponding to the header and a reference point corresponding to the feeder-house at the upcoming terrain at the worksite based, at least, on the identified one or more topographic characteristics of the upcoming terrain at the worksite.

11. The computer implemented method of claim 9, wherein obtaining data relative to the upcoming terrain at the worksite comprises one of:
obtaining overhead imagery of the worksite;
obtaining a map of the worksite;
obtaining data generated during a historical operation at the worksite; or
obtaining sensor data generated by an observation sensor system on the agricultural harvester.

12. The computer implemented method of claim 9, wherein identifying the one or more adjustments includes identifying a feeder-house position adjustment, wherein controlling one or more controllable subsystems includes controlling one or more feeder-house position actuators based on the identified feeder-house position adjustment.

13. The computer implemented method of claim 9, wherein identifying the one or more adjustments includes identifying a header position adjustment, wherein controlling one or more controllable subsystems includes controlling one or more header position actuators based on the identified header position adjustment.

14. The computer implemented method of claim 9, wherein identifying the one or more adjustments includes identifying an alignment adjustment that indicates an adjusted target alignment between the header and the feeder-house, wherein controlling one or more controllable subsystems includes controlling one or more actuators to adjust alignment between the header and the feeder-house based on the alignment adjustment.

15. The computer implemented method of claim 9 and further comprising:
comparing the identified future alignment between the header and the feeder-house at the upcoming terrain at the worksite to a target alignment between the header and the feeder-house; and
wherein identifying the one or more adjustments comprises identifying the one or more adjustments based on the comparison between the identified future alignment between the header and the feeder-house at the upcoming terrain at the worksite and the target alignment between the header and the feeder-house.

16. An agricultural system comprising:
one or more processors; and
memory storing instructions, executable by the one or more processors, that, when executed by the one or more processors, cause the one or more processors to:
identify one or more topographic characteristics of upcoming terrain at a worksite based on data indicative of the one or more topographic characteristics of the upcoming terrain at the worksite;
identify a future alignment between a header of an agricultural harvester and a feeder-house of the agricultural harvester at the upcoming terrain at the worksite based, at least, on the identified one or more topographic characteristics of the upcoming terrain at the worksite;
identify one or more adjustments based on the identified future alignment between the header and the feeder-house at the upcoming terrain at the worksite; and
control one or more controllable subsystems of the agricultural harvester based on the identified one or more adjustments.

17. The agricultural system of claim 16, wherein the one or more adjustments include a feeder-house position adjustment, wherein the one or more controllable subsystems include one or more feeder-house position actuators, and wherein the instructions, when executed by the one or more processors, cause the one or more processors to control the one or more feeder-house position actuators based on the feeder-house position adjustment.

18. The agricultural system of claim 17, wherein the one or more alignment adjustments include a header position adjustment, wherein the one or more controllable subsystems include one or more header position actuators, and wherein the instructions, when executed by the one or more processors, cause the one or more processors to control the one or more header position actuators based on the header position adjustment.

19. The agricultural system of claim 17, wherein the one or more adjustments include an alignment adjustment that indicates an adjusted target alignment between the header and the feeder-house, wherein the one or more controllable subsystems include one or more actuators operable to adjust alignment between the header and the feeder-house, and wherein the instructions, when executed by the one or more processors, cause the one or more processors to control the one or more actuators based on the alignment adjustment.

20. The agricultural system of claim 16, wherein the instructions, when executed by the one or more processors, further cause the one or more processors to:
compare the identified future alignment between the header and the feeder-house at the upcoming terrain at the worksite to a target alignment between the header and the feeder-house; and
identify the one or more adjustments based on the comparison between the header and the feeder-house at the upcoming terrain at the worksite and the target alignment between the header and the feeder-house.
